(19) United States
(12) Patent Application Publication
(10) Pub. No.: US 2012/0324791 A1
(43) Pub. Date: Dec. 27, 2012

(54) System and method for sensing a gate obstruction

(75) Inventors: Alex Parsadayan, Monarch Beach, CA (US); Wayne C. Hom, Coto De Caza, CA (US)

(73) Assignee: Maximum Controls, L.L.C.

(21) Appl. No.: 13/135,058

(22) Filed: Jun. 24, 2011

(51) Int. Cl. E05F 15/20; E06B 7/00

(52) U.S. Cl. 49/26; 49/506

(57) ABSTRACT

A system and method for detecting an object or obstruction in the path of a moveable barrier or automatic gate and allowing a coupled controller to determine corrective action prior to the moveable barrier coming in physical contact with such object or obstruction. A plurality of sensors in a physical array is used to detect such objects in the path of a barrier as it moves from closed to open and vice versa. The output of each respective sensor is compared to all of the others. In the preferred embodiment, if all of the sensor outputs are the same, it is assumed that there is no obstruction. However, if the output of any one sensor differs from the output of another sensor, it is assumed that there is an obstruction and the gate is either stopped or reversed before contact is made.

### BACKGROUND OF THE INVENTION

1. Field of the Invention

The present invention relates to the field of automatic gates. More specifically, the invention relates to methods and devices for controlling the operation of moveable barriers. The invention relates to apparatus for detecting objects or obstructions in the pathways of moveable barriers.

2. Background Art

Moveable barrier operators are automated systems which are utilized to move a barrier or gate between a fully open position and a fully closed position. Some examples of moveable barriers are sliding gates, swing gates, barrier arms and overhead doors. A typical moveable barrier operator consists of a motor coupled to a drive train attached to the moveable barrier to move the barrier between fully open and fully closed positions.

Such powered moveable barrier operators are controlled by various inputs to carry out an open, close or stop command. Inputs usually consist of wired contact switches, wireless receiver units along with their respective transmitters or a combination of both.

Obstructions may exist or enter the pathway of the moveable barrier. Previous systems have incorporated obstruction detection to allow the moveable barrier operator to sense when an object or obstruction has been encountered and to stop or reverse the direction of movement once the moveable barrier operator has determined that an object or obstruction has been encountered. Such systems typically detect obstructions by measuring barrier speed, measuring motor current or monitoring a safety switch input from an external contact detection device such as a Miller edge strip or an external non-contact device such as a photoelectric beam. Other prior art systems have used capacitive sensors or loop detectors as obstruction detectors.

A Miller edge strip relies on physical contact with the sensor. The photoelectric beam, though a non-contact system, has a limited field of detection. Safety loop systems are widely used, but they only detect vehicles. They cannot detect non-ferrous objects such as humans, pets or composite bicycles. Previous capacitive sensor systems use a reference member or sensing member coupled such that the reference member is maintained at a fixed distance from the sensing element. All of the prior art systems mentioned above have serious limitations as to their efficiency and overall safety. By way of example, contact sensors or photoelectric beams could result in inadvertent injury or damage despite the attempt to avoid such results.

### SUMMARY OF THE INVENTION

A system and method for the determination of an object or obstruction in the pathway of a moveable barrier should also avoid false detection of objects or obstructions. In the preferred embodiment hereof an array of sensor elements is positioned on the edge of a moveable barrier and the output of each sensor element is measured. A sensor circuit coupled to the sensor elements determines whether an object or obstruction is in the pathway of the moveable barrier by comparing the relative measurements of the sensor elements. This system and method is relatively inexpensive and can be implemented on conventional movable barrier systems.

In one embodiment of the invention, an array of sensors is positioned on the leading edge of a moveable barrier. The output of each sensor is measured and the reading of each sensor is compared to the readings of the other sensors. If one or more sensor readings are substantially different than the rest of the readings, it can be inferred that an obstruction or object exists in the pathway of the moveable barrier. If all of the measured sensor readings are substantially similar, it can be determined that there is no object or obstruction in the pathway of the moveable barrier even as the moveable barrier approaches its endpoint where a pillar or fence post may exist. If it is determined that an object or obstruction exists in the pathway of the moveable barrier, the sensor controller can then signal the moveable barrier controller to either stop or reverse the direction of the moveable barrier prior to coming in contact with the obstruction or object in the pathway of the moveable barrier.

The moveable barrier may be any type of moveable barrier, including for example, a barrier arm, an overhead door, a swing gate, or a sliding gate.

Thus, in the present invention, a system and method are provided where a measurement made by each sensor of a plurality of sensors is compared to the other sensors to determine if an object or obstruction exists in the pathway of a moveable barrier. A substantially different reading from one or more sensors is an indication of an object or obstruction in the pathway of the moveable barrier. However a substantially similar reading from all sensors is indicative of the absence of an object or obstruction in the pathway of the moveable barrier.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a front view schematic diagram of a sensor array deployed on a swing gate system according to an embodiment of the present invention;

FIG. 2 is a top view of the system of FIG. 1;

FIG. 3 is a schematic diagram of a sensor array deployed on a sliding gate system according to an embodiment of the present invention;

FIG. 4 is a schematic front view of a barrier arm gate system;

FIGS. 5 and 6 are respective block diagrams of wired and wireless systems using a sensor array according to one preferred embodiment of present invention; and

FIGS. 7 and 8 provide a block diagram and a logic diagram, respectively, used in a preferred embodiment of the invention.

Those skilled in the art will appreciate that the elements in the figures are illustrated for simplicity and clarity and are not necessarily drawn to scale.

### DETAILED DESCRIPTION OF PREFERRED EMBODIMENTS

For illustrative purposes, the following description refers to a moveable barrier that is a swing gate. However, it will be understood by those skilled in the art that the moveable barrier can be any type of barrier such as a sliding gate or a barrier arm or any other type of moveable barrier.

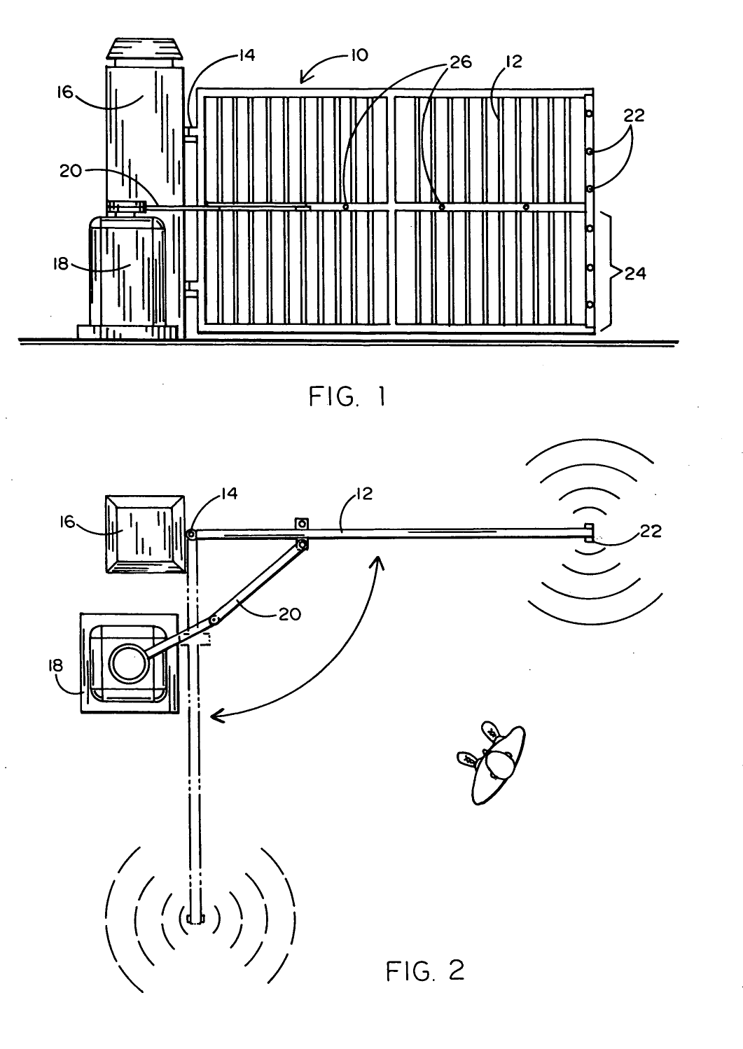

Referring now to FIGS. 1 and 2, a swing gate system 10, comprises a swinging gate 12 attached by way of hinges 14 to a fence post 16 and coupled to a swing gate operator 18 by way of an articulating arm 20 to move the swing gate 12 between a fully closed position and a fully open position.

The swing gate 12 has a sensor array system 22 mounted to the leading edge of the swing gate. The sensor array system 22 can be mounted to the swing gate to form either a vertical array 24 or a horizontal array 26 to provide the best object or obstruction detection according to the individual swing gate system installation.

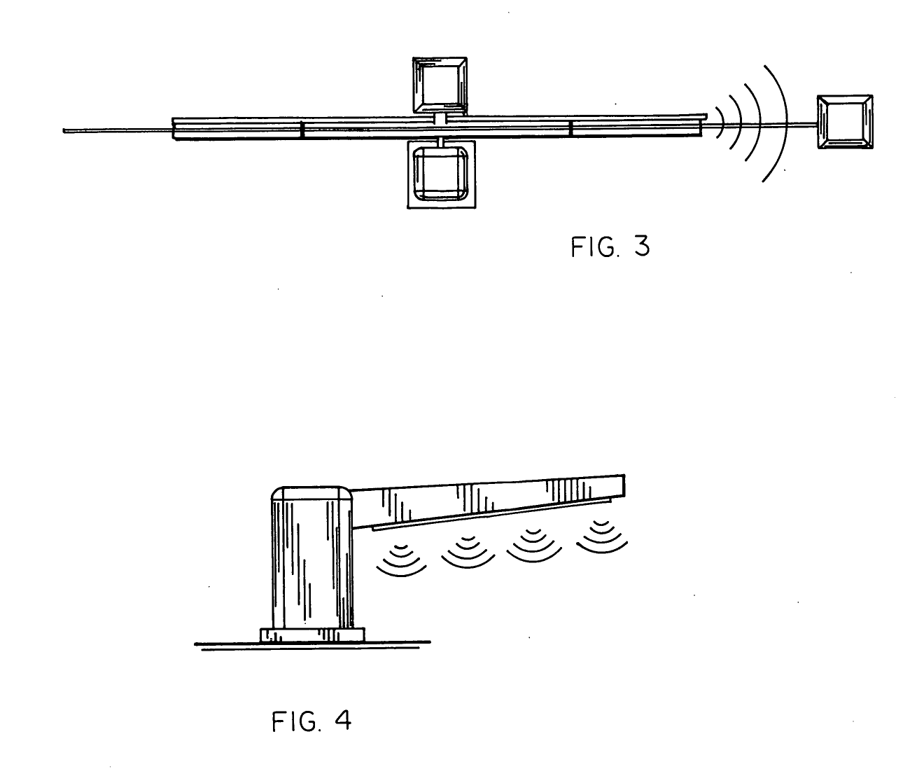

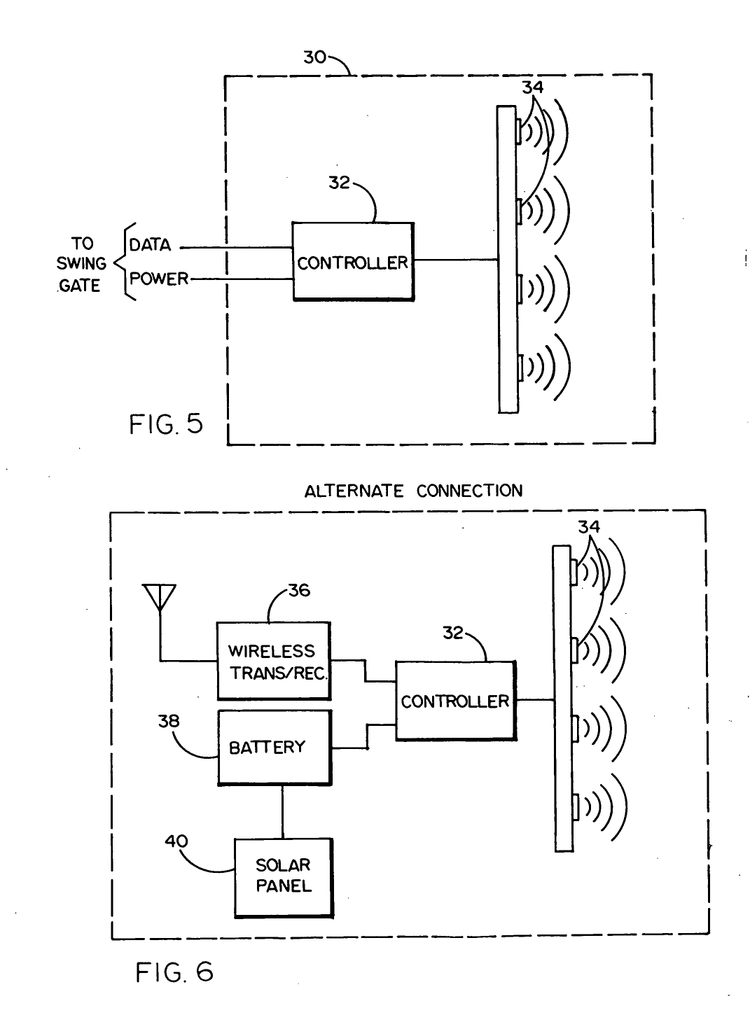

Examples of a sliding gate is shown in FIG. 3 and of a lift gate is shown in FIG. 4.

Referring now to FIG. 5, an example of a sensor array system is described. A sensing system 30 includes a controller 32 and a sensor array 34. The controller 32 is coupled to the swing gate operator by way of direct wires for the signal lines and power input from the swing gate controller. Alternatively, the controller 32 could be equipped with a wireless transceiver 36, a battery 38, and an optional charging source such as a solar panel 40. The battery supplies power to the sensor array system while signals are sent and received wirelessly.

The sensor array 34 detects changes in capacitance and is read by controller 32. If the detected changes occur such that on object or obstruction in the pathway of the swing gate is detected, the controller 32 signals the swing gate operator either through the connecting wires or alternatively through the wireless transceiver. The swing gate operator may then stop or reverse the direction of the swing gate.

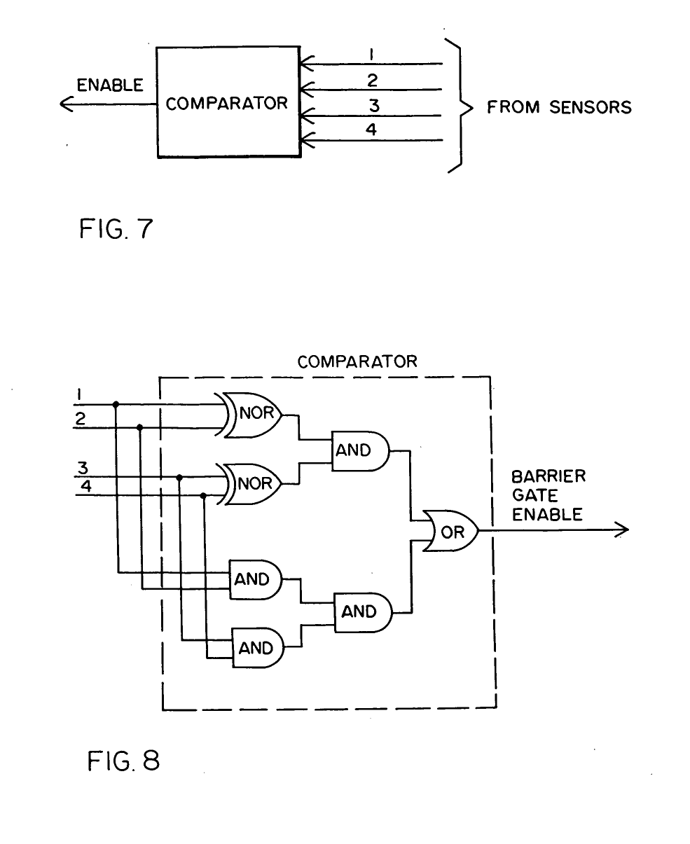

In the preferred embodiment of the present invention, a plurality of sensors form a distributed array which monitor the entire length of the gate. The gate is enabled if and only if all of the sensors detect the same status. If all of the sensors “see” a target, it is assumed that they have detected a fixed non-interfering target structure such as a wall or tree in the distance that would not constitute an obstruction to movement of the gate. Of course, if all of the sensors do not sense a target, there is no obstruction that could interfere with the gate. On the other hand, if only one or more of the sensors “sees” a target, but not all of them, then it is more likely to be an actual obstruction such as a car or a person. FIGS. 7 and 8 illustrate one way of implementing such a scheme for the sensors. FIG. 7 shows that the sensors 1, 2, 3 and 4 are all connected to a comparator which can generate an enable signal to operate the gate or barrier if the aforementioned conditions are detected, namely, if all of the sensors see the same thing. However, if only 1, 2, or 3 sensors see something different from the remaining sensor(s), the enable signal is not generated thereby stopping or reversing motion of gate. Implementation of the comparator in this exemplary embodiment, is shown in FIG. 8. A combination of logic gates (NOR gates for sensing all “zeros” and AND gates for sensing all “ones”) is used to generate a barrier gate enable signal if and only if all of the sensors detect the same condition. Otherwise, if any one, two or three sensors detects a condition that is different from the remaining sensor(s), the enable signal is not generated.

While there has been illustrated and described a particular embodiment of the present invention, it will be appreciated that changes and modifications will occur to those skilled in the art and that such changes and modifications may be made to the illustrated embodiments without departing from the spirit of the present invention.

We claim:

1. A method of sensing an object or obstruction in the pathway of a moveable barrier comprising a controller and a sensor array; the method comprising the steps of:
reading each sensor of the sensor array;
analyzing the readings of each sensor;
determining if the sensor readings are different from one another to indicate the presence of an object or obstruction in the pathway of the moveable barrier;
determining if the sensor readings are all the same to indicate the absence of an object or obstruction in the pathway of the moveable barrier; and
generating a signal indicating the presence or absence of an object or obstruction in the pathway of the moveable barrier.

2. The method of claim 1 where the presence of an object or obstruction is determined by one or more sensor readings being different than the other sensor readings.

3. The method of claim 1 where the absence of an object or obstruction is determined by all of the sensor readings being similar.

4. A system for sensing an object or obstruction in the pathway of a moveable barrier comprising a controller, a sensor array containing a plurality of sensors, a power source and a device for signaling the presence or absence of an object or obstruction in the pathway of a moveable barrier depending on whether the output of any one sensor is different from the other sensor output

5. The system of claim 4 where the sensor array comprises a minimum of two sensors.

6. The system of claim 4 where the sensor array comprises inductive sensors.

7. The system of claim 4 where the sensor array comprises capacitive sensors.

8. The system of claim 4 where the sensor array comprises optical sensors.

9. The system of claim 4 where the power source is provided by an external control system.

10. The system of claim 4 where the power source comprises a battery.

11. The system of claim 4 where the power source comprises a rechargeable battery coupled to a solar cell.

12. The system of claim 4 where the device for signaling the presence or absence of an object or obstruction is sent through connecting wires.

13. The system of claim 4 where the device for signaling the presence or absence of an object or obstruction is sent wirelessly through a wireless transceiver.
